(19) United States
(12) Patent Application Publication
(10) Pub. No.: US 2010/0077621 A1
(43) Pub. Date: Apr. 1, 2010

(54) VEGETATION CUTTING TOOL

(76) Inventors: Andrew QUIGLEY, Matlock (GB); Richard POOLE, Suffolk (GB); Nicholas BUTCHER, Ipswich (GB); Andriy DENYSOV, Middlesex (GB)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/547,366

(22) Filed: Aug. 25, 2009

(30) Foreign Application Priority Data
Aug. 26, 2008 (EP) 08105135.1

(51) Int. Cl. B26B 15/00

(52) U.S. Cl. 30/228

(57) ABSTRACT

The present invention relates to a vegetation cutting tool. In particular, the present invention relates to a powered vegetation cutting tool and more particularly to a linkage mechanism for a powered vegetation cutting tool. We describe a vegetation cutting tool comprising a cutting head, a motor and transmission means drivable by the motor. The cutting head includes first and second cutter members having respective cutting surfaces, wherein the first cutter member is pivotably mounted with respect to the second cutter member. Additionally, at least the first cutter member is drivable by the transmission means between a first angular position with respect to the second cutter member, in which a space is formed between the respective cutting surfaces, and a second angular position with respect to the second cutter member, in which the space between the respective cutting surfaces is closed. The transmission means also comprises an engagement means associated with the first cutter member, and a crank drivable between defined first and second angular crank positions corresponding to the first and second angular positions, in which the crank is operatively coupled to the engagement means by a link.

### CROSS REFERENCE TO RELATED APPLICATIONS

This application is based on EP Application No. 08105135.1 filed Aug. 26, 2008.

### BACKGROUND OF THE INVENTION

1. Field of the Invention

The present invention relates to a vegetation cutting tool. In particular, the present invention relates to a powered vegetation cutting tool and more particularly to a linkage mechanism for a powered vegetation cutting tool.

2. Description of the Prior Art

Vegetation cutting tools such as pruning tools and secateurs are well known for use in cutting plant stems and trees and shrub branches There are three basic types of secateur: “anvil”, which comprise a single blade that can be moved against a fiat surface to cut a stem; “bypass”, which usually comprise a pair of blades (often just one of the blades has a cutting surface) that are operated like a pair of scissors, and which provide a shearing force to cut the stem as the blades are moved passed each other; and “parrot-beak”, which are also operable like a pair of scissors and which comprise a pair of concave blades, between which a stem can be trapped and cut.

Pruning tools may be manually operated or driven, usually by an electrical motor. Powered pruning tools operate to move at least one blade of a pair of blades between an open configuration, in which cutting edges of the moveable blade and a fixed blade are apart, and a closed configuration, in which the cutting edges of the blades abut or just pass one another. If powered cutting action is conducted in response to the actuation of an external user-control in the form of a button or trigger. When the user-control is released, the blades return to the open configuration. Typically, this is achieved by a reduction gearbox driving a partial gear segment on the moving blade.

For example, EP 803187 A2 describes a set of pruning shears which have two relatively adjustable cutting blades, one of which is secured to the housing of the shears, the other operated by an electric motor. The fixed blade is secured with a threaded spindle, a spindle nut and a displacement rod. The operation of the electric motor is controlled via a control switch with a pair of switch elements inserted in the electric motor current circuit. The spindle nut has a cam guide for control cams associated with the switch elements.

Electric scissors are also known. However, these devices operate by reciprocating the blades repeatedly to perform a sequence of cutting and opening movements. Unlike pruning tools, the scissor blades operate in a continuous manner without the need for a stop/reverse function. For example, US 2005/0160606 A1 describes a pair of electric scissors comprised of a casing, a motor, a driving disk, a crank, and a cutting unit with a pair of blades. The driving disk, crank and blades of the cutting unit are connected pivotally and eccentrically. The motor is installed with a speed change device so that the rotation speed of the motor, and thus the rotary shaft, can be reduced to provide a higher torsion force for cutting tougher objects.

Whilst the construction described in US 2005/0160606 A1 is appropriate for light duty use, its overhung loads and continuous operation make it unsuitable for pruning tools which utilise a single cutting operation that requires a far greater torsion force for the cutting operation.

The present invention seeks to overcome at least some of these disadvantages.

### SUMMARY OF THE INVENTION

Accordingly, the present invention provides a vegetation cutting tool comprising a cutting head, a motor and transmission means drivable by the motor, wherein the cutting head comprises first and second cutter members having respective cutting surfaces, wherein the first cutter member is pivotably mounted with respect to the second cutter member, and wherein at least the first cutter member is drivable by the transmission means between a first angular position with respect to the second cutter member, in which a space is formed between the respective cutting surfaces, and a second angular position with respect to the second cutter member, in which the space between the respective cutting surfaces is closed, and wherein the transmission includes an engagement element associated with the first cutter member, and a crank drivable between defined first and second angular crank positions corresponding to the first and second angular positions, in which the crank is operatively coupled to the engagement means by a link.

Preferably, the transmission includes a reduction gear assembly, including an output bearing, which is drivable by the motor, and in which the crank is drivable by the gear assembly.

Preferably, the first cutter member comprises a cutting surface having a sharpened leading edge.

In one embodiment, the first cutter member is moveable in a plane parallel and adjacent to the plane in which the second cutter member lies, and is arranged to be slidably drivable over a surface of the second cutter member.

In an alternative embodiment, the first and second cutter members are arranged such that the cutting surface of the first cutter member is drivable against a cutting surface of the second cutter member.

Preferably, the engagement element has a tab formed on the first cutter member. Preferably, the link has a slot which is operatively engageable with the tab.

Suitably, the vegetation cutting tool comprises a user-control for activating the motor. Preferably, the user-control provides a non-continuous activation of the motor, in use. Preferably, the user-control is moveable between first and second positions to effect movement of the first moveable member between the first and second angular positions, and wherein release of the user-control, in use, causes the first cutter member to move to the first angular position.

Preferably, the user-control comprises a trigger. Preferably, the release of the trigger, in use, causes the first cutter member to return to the first angular position.

Suitably, the crank comprises a crank body and crank arm. Preferably, the crank body is operatively coupled to an output shaft of the motor or reduction gearbox. Preferably, the crank is operatively connected to the link such that the connection is substantially in-line with the gear assembly output bearing.

Preferably, the motor is a direct current motor.

Preferably, the vegetation cutting tool is battery-powered. Preferably, the battery is rechargeable; more preferably, the battery is a lithium-ion battery.

Suitably, the vegetation cutting tool further comprises one or more limit switches. At least one limit switch breaks the supply of power to the motor when the at least one of the cutter members has moved from the first angular position to the second angular position, in operation. Preferably, the one or more limit switches enable a short circuit across the motor terminals when the at least one of the cutter members has moved from the first angular position to the second angular position, in use. Preferably, the one or more limit switches activate relays to make or break the motor electrical connections, in use. Preferably, two relays are activated, in use. Preferably, the two relays are formed as a single twin-relay component.

Preferably, the gearbox is an epicyclic unit mounted coaxially to the motor. Suitably, the gearbox has a reduction ratio of between 300:1 and 700:1; preferably, between 400:1 and 600:1; more preferably about 516:1. Preferably, the reduction is carried out by means of a four stage assembly.

Suitably, the first cutter member is pivotably mounted with respect to the second cutter member by a pin and pivot bush. Preferably, the first cutter member is demountable. Suitably, the first cutter member is demountable by means of disengagement of the engagement means from the link, and by removal of the pin and pivot bush.

Preferably, the link is retained in position when the first cutter member is removed. Preferably, the cutting head comprises a linkage mounting moulding having a channel, and the link is moveable within the channel, to retain its position relatively with the linkage mounting moulding. Suitably, the link further comprises an integral link tab, formed therewith, and the link tab is moveable within the channel in the linkage mounting moulding.

Preferably, the link comprises a link aperture at an operatively upper end which is rotatably engaged with the crank to provide a mechanical engagement between the link and crank.

Preferably, the cutting head and transmission is formed as a single working unit.

Suitably, the pin is a screw or threaded fixing, such as a bolt.

### BRIEF DESCRIPTION OF THE DRAWINGS

The above and other aspects of the present invention will now be illustrated in further detail, by way of example only, with reference to the accompanying drawings in which:

FIG. 1 is a perspective view of an embodiment of a vegetation cutting tool in accordance with the invention;

FIG. 2 is a perspective view of the principal components of the operating mechanism of the embodiment of FIG. 1, in which the cutter members are in a first position;

FIG. 3 is a perspective view of the principal components of the operating mechanism of the FIG. 1, in which the cutter members are in a second position;

FIG. 4 is an exploded simplified perspective view of the mechanism of the embodiment of FIG. 1;

FIG. 5 is an exploded detailed perspective view of the mechanism of the embodiment of FIG. 1;

FIG. 6 is an alternative exploded detailed perspective view of the mechanism of the embodiment of FIG. 1; and

FIG. 7 is a graph depicting blade movement as a function of crank movement.

### DESCRIPTION OF THE PREFERRED EMBODIMENTS

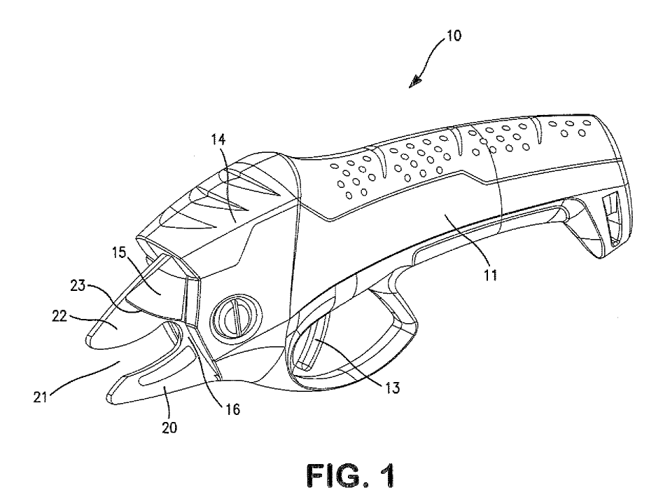

Referring to FIG. 1, there is shown a vegetation cutting tool in the form of a pruner 10 generally of the bypass type and comprising an elongate handle 11 including a user-control in the form of a trigger 13. Handle 11 further includes a cutting head 14 located at a front end of handle 11, the cutting head 14 comprising a moveable cutter member 15 and a fixed cutting head element in the form of a plate 16. Plate 16 comprises a fixed cutting member 20 and a vegetation guide 22 forming a vegetation-receiving channel 21 therebetween.

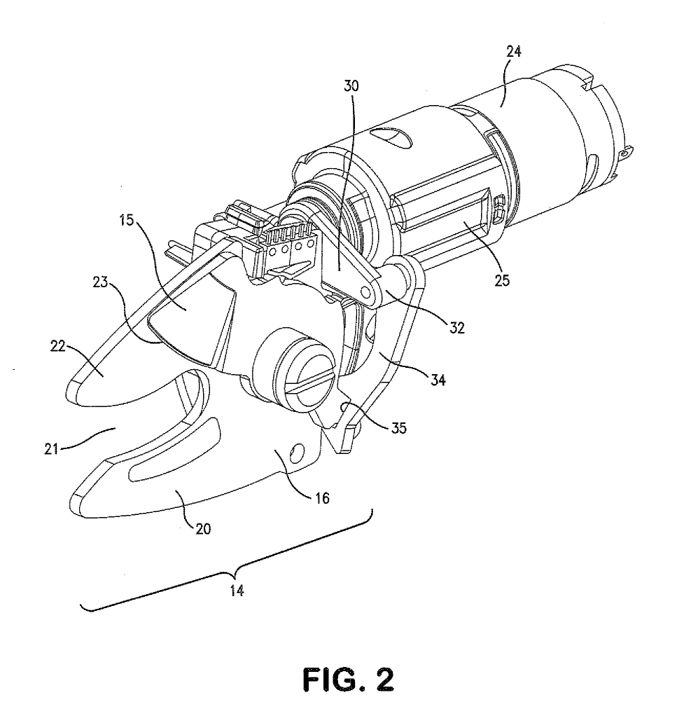

Moveable cutter member 15 includes a sharpened leading or cutting edge 23 and is pivotally drivable, in use, between retracted and extended positions by a motor (24 in FIG. 2). When the moveable cutter member 15 is in the retracted position, as shown in FIG. 1, moveable and fixed cutter members 15, 20 are operatively spaced, and the sharpened leading edge is retracted and protected by vegetation guide 22, and vegetation-receiving channel 21 is open.

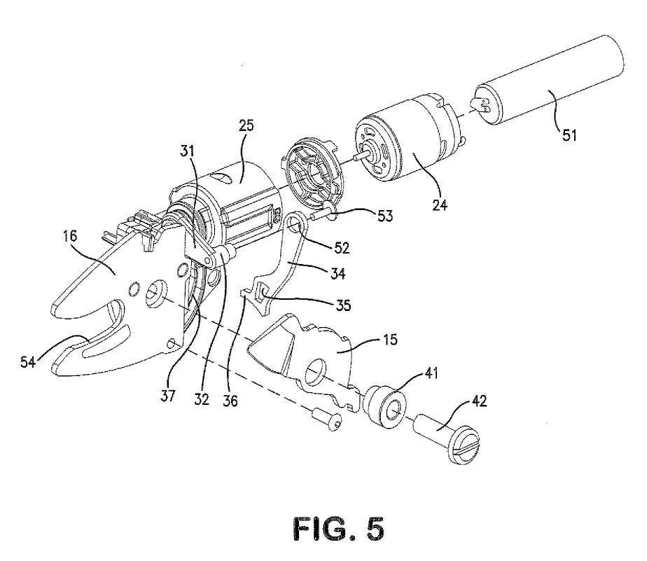

In use, the action of driving moveable cutter member 15 towards the fixed cutter member 20 and particularly its unsharpened leading edge 54 of the fixed cutter member (FIG. 5) provides a shearing action therebetween in the manner of a bypass-type pruner. That shearing action can be used to cut any vegetation which has been located within the vegetation-receiving channel 21. In alternative embodiments, the action of driving the moveable cutter member 15 towards the fixed cutter member 20 provides a simple cutting force therebetween, in which a sharpened leading edge of the moveable cutter member 15 forces the article to be cut against the fixed cutter member 20 to thereby cut the article in the manner of a anvil-type pruner.

In the illustrated embodiment, the fixed cutter member 20 is not moveable. However, in alternative embodiments (not shown) second cutter member 20 is reciprocally drivable relative to the moveable cutter member 15.

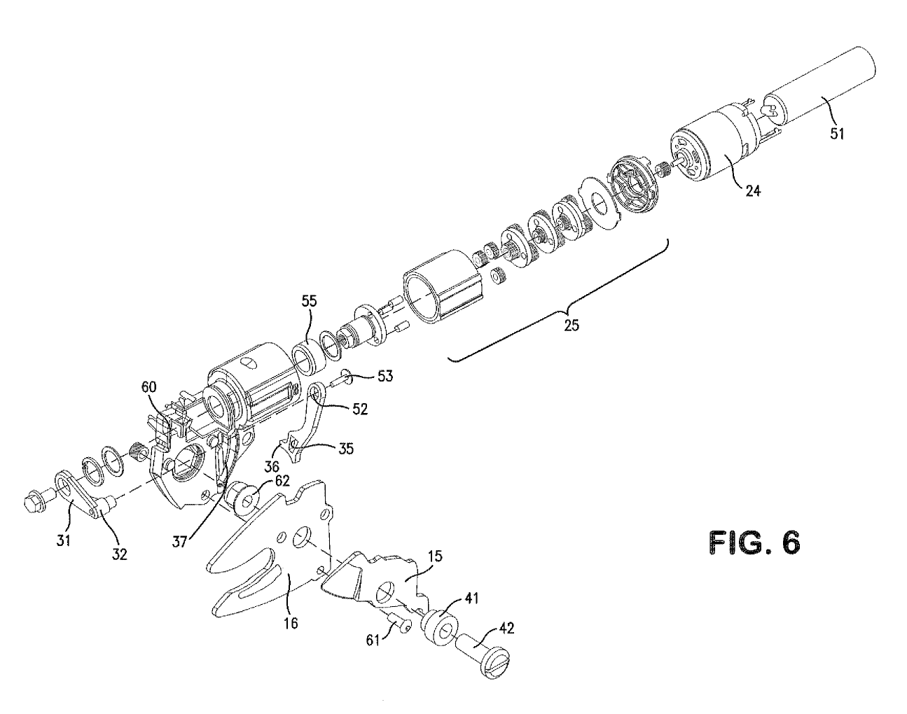

FIG. 2 shows the assembled mechanism of the pruner 10 with the moveable cutter member 15 in a retracted position, leaving vegetation-receiving channel 21 open for receipt of vegetation. The mechanism includes a motor 24 connected coaxially to a gearbox unit 25. The gearbox unit 25 is suitably a four-stage epicyclic gearbox (see FIG. 6) which provides a reduction in the motor speed in the ratio of around 516:1. A crank 30 is rotatably attached to the gearbox output shaft (obscured), and comprises a crank body 31 and crank arm 32. Crank body 31 is connected to the output shaft of the gearbox unit 25. In the embodiment shown, crank arm 32 is orientated to extend backwards towards the gearbox unit 25 at its outer end, such that a point of connection with 25 the cutting head is substantially in line with an end bearing 55 of the gearbox. As a result, any overhung bearing loads on the output shaft are reduced.

As can be seen most clearly in FIG. 4, moveable cutter member 15 includes an aperture 39 through which a pivot bush 41 is inserted and secured by pin in the form of a bolt 42 to mount moveable cutter member 15 pivotally upon plate 16 about a pivot point defined by the outer surface of pivot bush 41. Moveable cutter member 15 includes a tab 40.

As best shown in FIGS. 5 and 6, the mechanism further includes a link 34 which links crank arm 32 to the moveable cutting member 15. Link 34 includes a link aperture 52 at an operatively upper end (FIG. 5) which rotatably engages with crank arm 32 to provide a mechanical engagement between the link 34 and crank 30. The link 34 is retained on the crank arm 32 by a threaded bolt, or screw 53. The link 34 also includes a slot 35 provided at an operatively lower end of link 34 which operatively engages with the moveable cutter member 15 through tab 40.

In FIG. 6, the complete linkage assembly is shown. The linkage assembly is formed as a ‘self-contained’ unit around a linkage mounting moulding 60. Plate 16 is securely fixed to the linkage mounting moulding 60 by suitable securing means, for example a screw 61. As discussed above, moveable cutter member 15 is rotatably mounted on plate 16 by pivot bush 41 and bolt 42. As can be seen in exploded FIG. 6, bolt 42 passes through moveable blade 15 and plate 16 and fastens into captive nut 62 which is retained between the linkage mounting moulding 60 and plate 16.

The gear assembly, incorporating the output shaft end bearing 55 is housed within the linkage mounting moulding 60 to provide the ‘self-contained’ unit. Furthermore, the linkage mounting moulding 60 includes a groove or channel 37 in which a portion of the link 34 is moveable, and which restricts the range of movement of the link 34, during normal operation. In preferred embodiments, link 34 comprises a protrusion or link tab 36 which is moveable within channel 37 of the linkage mounting moulding 60.

Accordingly, in use, rotation of crank 30 by means of motor 24 causes link 34 to move in an upwards direction (in terms of the orientation shown in the Figures). As a result, the link 34 acts on the moveable cutter member 15, through the slot-tab engagement, to cause moveable cutter member 15 to rotate about the pivot point.

The offset formed between crank body 31 and crank arm 32 has the effect that its engagement with the link 34 is substantially in-line with the gearbox output shaft end bearing 55. This arrangement reduces the occurrence of bending loads on the gearbox output shaft and removes the need for additional load-carrying bearings.

Moveable cutter member 15 also includes profiles 44, 44′ which, in use, sequentially actuate a pair of electrical limit switches 45, 50 located on or adjacent plate 16, in response to the moveable cutter member being moved between retracted and extended positions. In particular, when the moveable cutter member is moved between the two positions, the profiles act upon electrical limit switches 45, 50 to indicate to the pruner control electronics (omitted for clarity) that the cutter member has reached the respective fully retracted or extended position. This causes the power supplied to the motor to be switched off, suitably, by means of electrical relays (not shown). Preferably, when the power to the motor is switched off a short-circuit is also applied to the motor terminals to provide a rapid braking effect upon the cutter member.

A limit to the angular movement of crank 30 is provided by mechanical means, in this case by contact between the crank and a linkage mounting moulding of the pruner (not shown). In preferred embodiments, movement of the link 34, and thus the crank 30 and moveable cutter member 15, is restricted due to the constraints imposed by the operative engagement of the integral link tab 36 of link 34 within channel 37 provided in the linkage mounting moulding (FIG. 6).

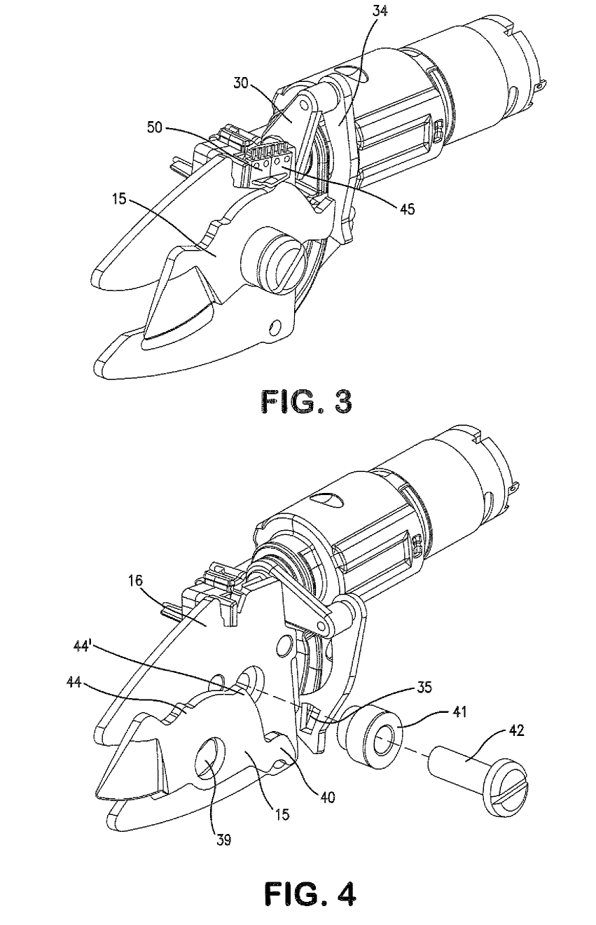

Referring now to FIG. 3 there is shown a view of the mechanism in which the moveable cutter member 15 is in an extended position. As shown, activation of trigger 13 has caused the motor 24 to be energised to rotate the crank arm 32 through an angle of around 75 to 80 degrees. As a consequence, the closed limit switch 45 has been actuated by engagement with profile 44′ of cutter member 15 and power to the motor has been switched off. Ideally, the motor terminals have been short-circuited to achieve a braking effect. In preferred embodiments, the mechanism remains in this closed configuration until trigger 13 is released by the user.

The angular movement of crank 30 is also restricted by further mechanical means, such as by contact between the moving blade and the linkage mounting moulding of the pruner adjacent to the tab 40 (not shown). Alternative assemblies such as engagement of a portion of link 34 and the linkage mounting moulding surface around the gearbox output shaft end bearing 55 can be used.

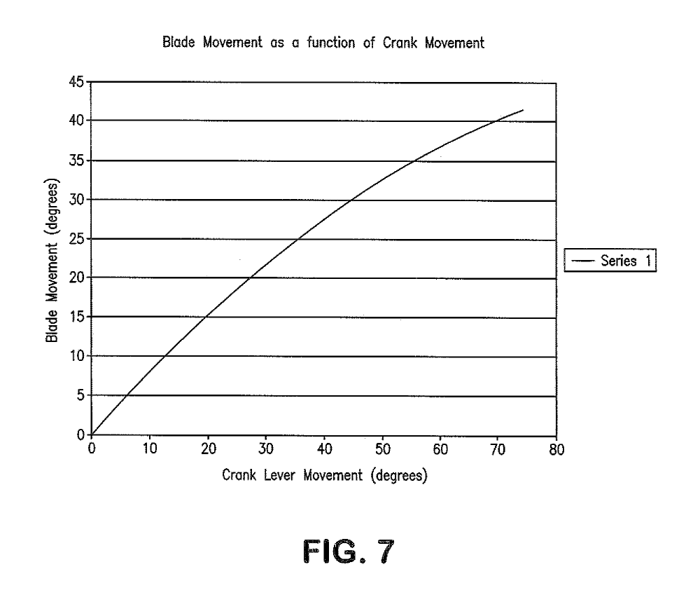

As illustrated in FIG. 7, the linkage mechanism described provides a mechanical advantage defined by the ratio between crank arm 32 angular rotation and moving blade (moveable cutter member) angular rotation. This mechanical advantage is variable throughout the cutting stroke of the moveable cutter member 15. A particular advantage of this arrangement is that the cutting force available to a branch of a particular diameter is then the same regardless of whether the branch is engaged by the moveable cutter member close to its pivot point (and therefore at a smaller moveable cutter member angular movement) or at its tip (and therefore at a greater moveable cutter member angular movement).

A further advantage of the described linkage mechanism is that the moveable cutter member 15 is easily demountable for sharpening or replacement. As shown in FIG. 4, this is achieved by removing the bolt 42 and pivot bush 41 whereupon the moveable cutter member can be demounted from the tool by removing its tab 40 from the slot 35 at the lower end of link 34. Advantageously, when the user removes or replaces the moveable cutter member, the operative engagement of link tab 36 within channel 37 provided in the linkage mounting moulding, ensures that the link 34 is appropriately retained in its correct position.

The linkage mechanism provides a low cost, compact and mechanically efficient design. It is especially suitable for application in portable battery-powered tools, such as pruners, in which the mechanism forms a self-contained working element formed around and located to a linkage mounting moulding within the moulding of the case in which the pruner is housed.

The pruner is ideally powered by one or more lithium-ion cells 51, due to their relative lightness in weight. The high efficiency of the mechanism means that the pruner tool can even be used with a single battery cell for cutting material up to 14 mm in diameter. For example, a suitable battery cell of 3.6 Volt, 1.3 Ah could achieve around 400 cuts of 12 mm diameter vegetation before recharging was required. In preferred embodiments, control electronics for the motor and or limit switch operations are also utilised to provide lithium-ion battery monitoring and controlling functions. For example, it may be desired to disable operation of the motor in the event that the battery becomes discharged below a pre-selected voltage or its temperature exceeds a predefined limit.

The foregoing relates to the preferred exemplary embodiments of the invention, it being understood that other variants and embodiments thereof are possible within the spirit and scope of the invention, the latter being defined by the appended claims.

1-15. (canceled)

16. A vegetation cutting tool comprising a cutting head, a motor and transmission drivable by the motor;
wherein the cutting head comprises first and second cutter members having respective cutting surfaces, wherein the first cutter member is pivotably mounted with respect to the second cutter member;
wherein at least the first cutter member is drivable by the transmission between a first angular position with respect to the second cutter member, in which a space is formed between the respective cutting surfaces, and a second angular position with respect to the second cutter member, in which the space between the respective cutting surfaces is closed; and wherein the transmission comprises an engagement element associated with the first cutter member, and a crank drivable between defined first and second angular crank positions corresponding to the first and second angular positions, in which the crank is operatively coupled to the engagement element by a link.

17. A vegetation cutting tool as claimed in claim 16, wherein the transmission further comprises a reduction gear assembly, including an output bearing, which is drivable by the motor, and in which the crank is drivable by the gear assembly.

18. A vegetation cutting tool as claimed in claim 16, wherein the engagement element comprises a tab formed on the first cutter member.

19. A vegetation cutting tool as claimed in claim 17, wherein the engagement element comprises a tab formed on the first cutter member.

20. A vegetation cutting tool as claimed in claim 18, wherein the link comprises a slot which is operatively engageable with the tab.

21. A vegetation cutting tool as claimed in claim 19, wherein the link comprises a slot which is operatively engageable with the tab.

22. A vegetation cutting tool as claimed in claim 16, further comprising a user-control for non-continuous activation of the motor, wherein the user-control is moveable between first and second positions to effect movement of the first cutter member between the first and second angular positions, and wherein release of the user-control, in use, causes the first cutter member to move to the first angular position.

23. A vegetation cutting tool as claimed in claim 17, wherein the crank is operatively connected to the link such that the connection is substantially in-line with the gear assembly output bearing.

24. A vegetation cutting tool as claimed in claim 18, wherein the crank is operatively connected to the link such that the connection is substantially in-line with the gear assembly output bearing.

25. A vegetation cutting tool as claimed in claim 20, wherein the crank is operatively connected to the link such that the connection is substantially in-line with the gear assembly output bearing.

26. A vegetation cutting tool as claimed in claim 16, wherein the vegetation cutting tool further comprises one or more limit switches and wherein at least one limit switch breaks supply of power to the motor when the at least one of the cutter members has moved from the first angular position to the second angular position.

27. A vegetation cutting tool as claimed in claim 16, further comprising two limit switches, each associated with a relay to make or break motor electrical connections, wherein the relays are a single twin relay.

28. A vegetation cutting tool as claimed in claim 17, wherein the reduction gear assembly is an epicyclic reduction gear assembly mounted coaxially to the motor.

29. A vegetation cutting tool as claimed in claim 25, wherein the reduction gear assembly is an epicyclic reduction gear assembly mounted coaxially to the motor.

30. A vegetation cutting tool as claimed in claim 16, wherein the first cutter member is demountable by means of disengagement of the engagement element from the link.

31. A vegetation cutting tool as claimed in claim 30, wherein the link is retained in position when the first cutter member is removed.

32. A vegetation cutting tool as claimed in claim 31, wherein the cutting head comprises a linkage mounting moulding, and the link is moveable within a channel provided in the linkage mounting moulding, to retain its position relatively with the linkage mounting moulding.

33. A vegetation cutting tool as claimed in claim 32, wherein the link further comprises an integral link tab, formed therewith, and the link tab is moveable within the channel in the linkage mounting moulding.

34. A vegetation cutting tool as claimed in claim 16, wherein the link comprises a link aperture at an operatively upper end which is rotatably engaged with the crank to provide a mechanical engagement between the link and crank.

35. A vegetation cutting tool as claimed in claim 16, wherein the cutting head and transmission means comprises a single working unit.
